(19) United States
(12) Patent Application Publication
(10) Pub. No.: US 2015/0135959 A1
(43) Pub. Date: May 21, 2015

(54) DEOXIDATION APPARATUS

(71) Applicants: Masahiro Takatsuka, Tokyo (JP); Hiroshi Okajima, Ibaraki (JP); Takahiro Matsumura, Ibaraki (JP); Hiromu Akita, Ibaraki (JP); Daisuke Koiwai, Ibaraki (JP)

(72) Inventors: Masahiro Takatsuka, Tokyo (JP); Hiroshi Okajima, Ibaraki (JP); Takahiro Matsumura, Ibaraki (JP); Hiromu Akita, Ibaraki (JP); Daisuke Koiwai, Ibaraki (JP)

(21) Appl. No.: 14/399,043

(22) PCT Filed: Aug. 30, 2012
(86) PCT No.: PCT/JP2012/005494

§ 371 Date: Nov. 5, 2014

(30) Foreign Application Priority Data
May 17, 2012 (JP) 2012-113694

(51) Int. Cl. B01D 19/00

(52) U.S. Cl. CPC B01D 19/0005; B01D 19/0047
USPC 96/203

(57) ABSTRACT

[Problem] To provide a deoxidation apparatus (4) with improved efficiency in absorbing degassing gas and dissolved oxygen in treated water.

[Solution] A deoxidation apparatus (4) in which by bringing the degassing gas into contact with the treated water, causes dissolved oxygen in treated water to be absorbed by degassing gas and lowers the dissolved oxygen concentration of the treated water. The deoxidation apparatus includes the following: a gas-liquid contact tower (42) that has the shape of a lower end open container, at least the lower end of which is submerged below the surface of the treated water that is to be treated, forming an internal sealed space (421); a degassing gas supply unit (43) that supplies degassing gas to the sealed space (421), filling the sealed space (421) with degassing gas; and a treated water dispersion unit (41) that disperses the supplied treated water within the sealed space (421) in the form of a mist through a dispersion nozzle unit (412).

### TECHNICAL FIELD

The present invention relates to a deoxidation technique of lowering the dissolved oxygen concentration with a degassing gas.

### BACKGROUND ART

A cooling water circulating system that allows water to cool, for example, a production equipment (hereinafter, referred to as a cooling target facility) which is heated to high temperature is introduced into factories and the like. This cooling water circulating system is a circulating line of water passing through the cooling target facility, and includes a cooler (heat exchanger) that cools (heat-exchanges) circulating water which has been warmed by cooling the cooling target facility, a water tank that once stores cooling water which has been cooled to a predetermined temperature by heat exchange at the cooler, a circulating pump that supplies cooling water stored in this water tank to the cooling target facility, and piping connecting these devices. Such a cooling water circulating system includes a deoxidation apparatus for lowering the dissolved oxygen concentration of cooling water to prevent oxidation and corrosion of each device in the circulating line of cooling water. For this deoxidation apparatus, a proposed technique so far is a system where the dissolved oxygen concentration of cooling water targeted for deoxidation treatment (target water) is lowered with nitrogen gas (Patent Literature 1).

The deoxidation apparatus disclosed in Patent Literature 1 involves submersion of the half of a deoxidation tower in a water tank and dropping and supply of the target water from the upper part of the deoxidation tower, while allowing nitrogen gas to be ejected from water in the deoxidation tower and to be brought into counter contact with droplets of dropping target water, which causes oxygen dissolved in the target water to be absorbed by nitrogen gas in the deoxidation tower.

Patent Literature 1: Japanese Patent Application Laid-Open No. 2010-5484

### SUMMARY OF INVENTION

### Technical Problem

The deoxidation apparatus disclosed in Patent Literature 1, however, fails to cause dissolved oxygen in target water to be sufficiently absorbed by nitrogen gas, and may cause corrosion of devices and piping in the circulating line of cooling water, requiring further lowering of the dissolved oxygen concentration.

Thus the present invention provides a deoxidation apparatus capable of improving the absorption efficiency of dissolved oxygen in the target water by nitrogen gas.

### Solution to Problem

In order to solve the above problem, the deoxidation apparatus of the present invention is (1) a deoxidation apparatus involving bringing a degassing gas into contact with target water, which causes dissolved oxygen in the target water to be absorbed by the degassing gas and lowers the dissolved oxygen concentration of the target water. The deoxidation apparatus includes: a gas-liquid contact tower that has a shape of a lower end open container thereof, at least the lower end being submerged below a surface of the target water to be treated, the gas-liquid contact tower thereby forming an internal sealed space; a degassing gas supply unit that supplies the degassing gas to the sealed space to fill the sealed space with the degassing gas; and a target water dispersion unit that disperses supplied target water within the sealed space in the form of a mist.

(2) The configuration described in (1) above is characterized in that the degassing gas and the target water are ejected upward.

(3) The configuration described in (1) or (2) above is characterized in that the gas-liquid contact tower is placed in a water tank for storing the target water.

(4) The configuration described in any one of (1) to (3) above is characterized in that an exhaust opening that exhausts gas in the sealed space out of the tower is provided at a lower part of a peripheral wall of the gas-liquid contact tower, and a surface level of the target water in the gas-liquid contact tower is set to be above the opening.

(5) The configuration described in any one of (1) to (4) above is characterized in including an ejector that premixes the degassing gas with the target water to be supplied to the target water dispersion unit.

### Advantageous Effects of Invention

According to the invention described in claim 1 of the present invention, (1) the exchange efficiency between nitrogen gas and dissolved oxygen in the target water can be improved.

(2) According to the invention described in claim 2 of the present invention, the contact time between the degassing gas and the target water dispersed in the form of a mist is increased while the degassing gas with which the sealed space is filled can be always maintained in a fresh condition.

(3) According to the invention described in claim 3 of the present invention, the target water stored in the water tank can be kept in the condition of low dissolved oxygen.

(4) According to the invention described in claim 4 of the present invention, the sealed space is provided in the gas-liquid contact tower and the degassing gas that has absorbed dissolved oxygen in the target water dispersed in the form of a mist can be discharged out of the gas-liquid contact tower through the exhaust opening.

(5) According to the invention described in claim 5 of the present invention, the particle size of the target water dispersed from a target water dispersion unit can be reduced, whereby the contact area between the degassing gas and the target water can be increased.

### BRIEF DESCRIPTION OF DRAWINGS

FIG. 1 is a schematic diagram of a cooling water circulating system to which a deoxidation apparatus of a first embodiment is applied.

FIG. 1A is an enlarged view of part A in FIG. 1.

FIG. 2 is a schematic diagram of the deoxidation apparatus according to the first embodiment.

FIG. 3 is a control flow chart of the cooling water circulating system to which the deoxidation apparatus of the first embodiment is applied.

FIG. 4 is a schematic diagram of a cooling water circulating system to which a deoxidation apparatus of a second embodiment is applied.

FIG. 5 is a schematic diagram of the deoxidation apparatus according to the second embodiment.

FIG. 6 is an x-z cross-sectional view of an ejector in the second embodiment.

FIG. 7 is a schematic diagram of a cooling water circulating system to which a deoxidation apparatus of a third embodiment is applied.

FIG. 8 is a schematic diagram of the deoxidation apparatus according to the third embodiment.

FIG. 9 is a schematic diagram of Comparative Example of the cooling water circulating system in the first to third embodiments.

FIG. 10 is a result of the comparison confirmation test for the deoxidation performance, where Examples 1 to 3 are compared with Comparative Example.

### DESCRIPTION OF EMBODIMENT

Next, the best mode for carrying out the present invention will be described in detail on the basis of the following embodiments.

### First Embodiment

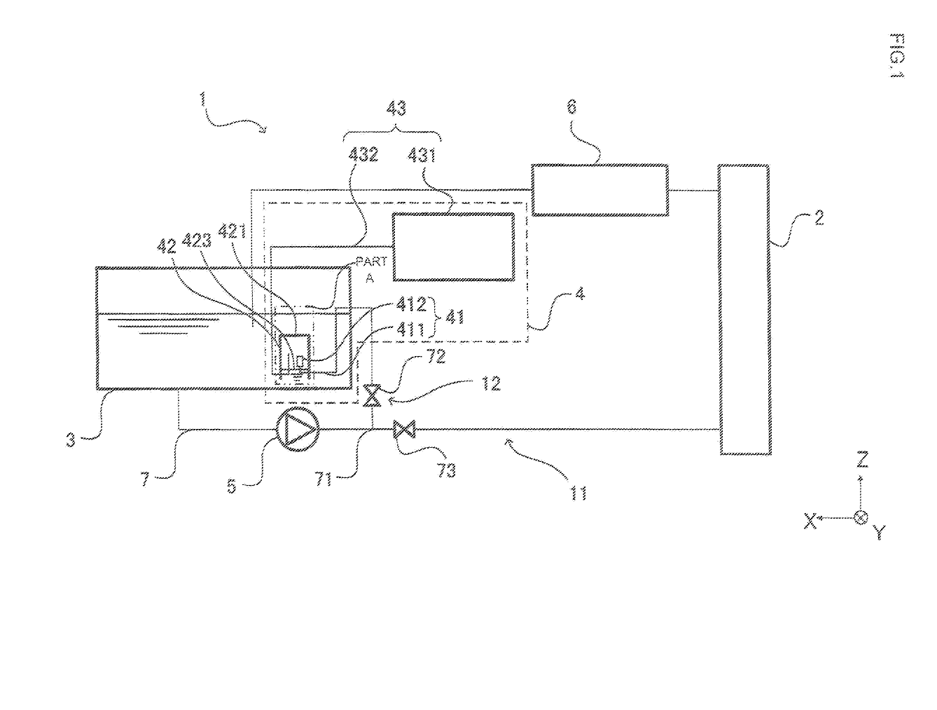

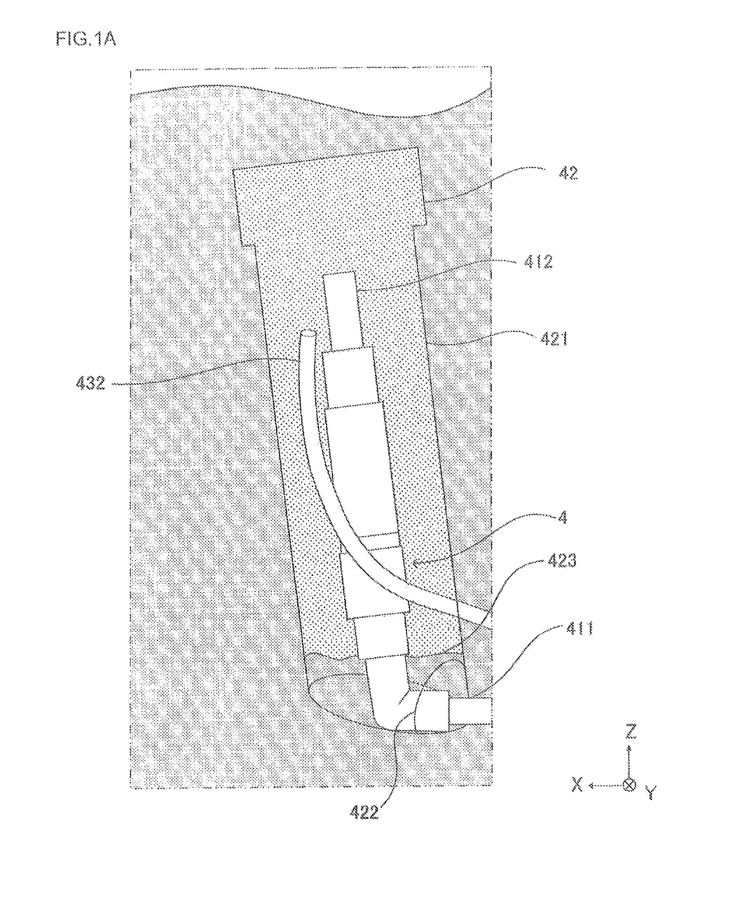

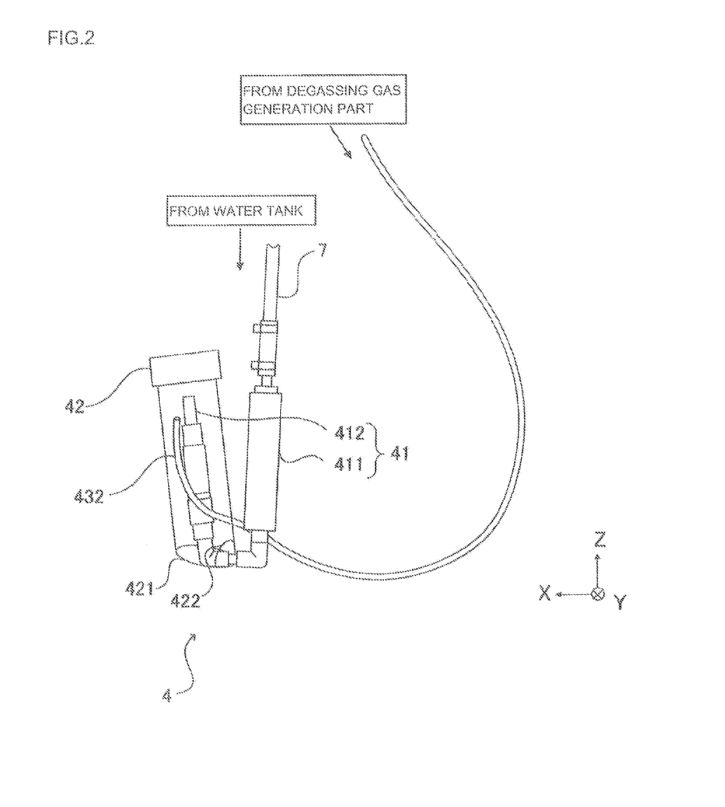

FIG. 1 is a schematic diagram of a cooling water circulating system 1 to which a deoxidation apparatus 4 of the first embodiment is applied; FIG. 1A is an enlarged view of part A in FIG. 1; and FIG. 2 is a schematic diagram of the deoxidation apparatus 4 of the first embodiment. Large dots in FIG. 1A indicate the target water dispersed in the form of a mist, and fine dots indicate cooling water (target water) stored in a water tank. In FIG. 2, in order to clarify the configuration, a gas-liquid contact tower 42 may be transparent for an observer to observe an internal target water dispersion unit 41. Furthermore, the length direction, the width direction, and the height direction of a water tank 3 are represented by an x-axis, a y-axis, and a z-axis, respectively.

As illustrated in FIG. 1, a cooling water circulation system 1 includes a cooling water circulating system 11 and a deoxidation treatment water circulating system 12.

The cooling water circulating system 11 includes: a cooling target facility 2; the water tank 3 that stores cooling water (target water) for cooling the cooling target facility 2; a circulating pump 5 that delivers the cooling water to the cooling target facility 2 from the water tank 3; a second flow control valve 73 that controls the flow rate of the cooling water delivered by the circulating pump 5; a cooler 6 (heat exchange means) that cools the cooling water which has been warmed by absorbing heat from the cooling target facility 2; and a circulating pipe 7 that connects these devices. Examples of the cooling target facility 2 may include press molding machines.

The deoxidation treatment water circulating system 12 includes: a branch connecting pipe 71 positioned between the circulating pump 5 and the second flow control valve 73; a first flow control valve 72 that controls the flow rate of the target water (cooling water) diverged from the branch connecting pipe 71; and the deoxidation apparatus 4 that lowers the dissolved oxygen concentration of the target water flowing in through the first flow control valve 72.

The water tank 3, as illustrated in FIG. 1, stores therein cooling water circulating through the cooling water circulating system 11 and cooling water (target water) circulating through the deoxidation treatment water circulating system 12 and having a lower dissolved oxygen concentration. The cooling water and the target water which are stored in the water tank 3 are delivered to the cooling target facility 2 and the deoxidation apparatus 4 with the circulating pump 5. The flow rate of the cooling water delivered to the cooling target facility 2 from the circulating pump 5 and the flow rate of the target water delivered to the deoxidation apparatus 4 from the circulating pump 5 are controlled by adjusting the aperture of the first flow control valve 72 and the second flow control valve 73 to attain the optimal flow rates.

Next, the deoxidation apparatus 4 of the present embodiment will be described. The deoxidation apparatus 4 is indicated by the region enclosed by a broken line illustrated in FIG. 1 and includes the target water dispersion unit 41, the gas-liquid contact tower 42, and a degassing gas supply unit 43.

The target water dispersion unit 41, as illustrated in FIG. 2, includes: a dispersion connecting pipe 411 which is connected to the circulating pipe 7 downstream of the first flow control valve 72; and a dispersion nozzle unit 412 which is connected to the dispersion connecting pipe 411 and disperses the target water in the form of a fine mist within the sealed space 421. A dispersion nozzle unit 412 is fixed to the gas-liquid contact tower 42 with a dispersion nozzle fixing member (not shown) while being inserted into the gas-liquid contact tower 42 described below. Dispersion of the target water in the form of a mist with the dispersion nozzle unit 412 can increase the contact area between the target water and the degassing gas with which the gas-liquid contact tower 42 is filled.

This dispersion nozzle unit 412 may be fixed to the gas-liquid contact tower 42 while facing upward. This configuration brings the degassing gas and the target water into contact with each other and causes dissolved oxygen in the target water to be absorbed by the degassing gas, during the movement of the target water dispersed from the dispersion nozzle unit 412 upward and downward (free fall). That is, the deoxidation apparatus 4 of the present embodiment can increase the contact distance (contact time) between the target water and the degassing gas when compared with a deoxidation apparatus 4 in which the degassing gas and the target water are brought into contact with each other by simply dropping droplets of the target water. The deoxidation apparatus 4 of the present embodiment can thus lower the dissolved oxygen concentration of the target water stored in the water tank 3, even if the height of the device is set to low.

The gas-liquid contact tower 42, as illustrated in FIGS. 1, 1A, and 2, has the shape of a lower end open container and at least the lower end is submerged below the surface 423 of the target water to be treated, thereby forming an internal sealed space 421. Specifically, as illustrated in FIGS. 1 and 1A, while the inside of the gas-liquid contact tower 42 is filled with the degassing gas, the entire gas-liquid contact tower 42 is submerged in the target water stored in the water tank 3 and fixed to the water tank 3 with a contact tower fixing member (not shown). By fixing the gas-liquid contact tower 42 to the water tank 3 in this manner, the surface 423 of the target water is formed at the lower part of the gas-liquid contact tower 42 to provide the sealed space 421 inside the gas-liquid contact tower 42. This configuration can press down the surface 423 of the target water formed at the lower part of the gas-liquid contact tower 42 to control an excessive increase of the pressure inside the gas-liquid contact tower 42, when the degassing gas is excessively contained in the gas-liquid contact tower 42 to increase the pressure inside the gas-liquid contact tower 42. As described above, the entire gas-liquid contact tower 42 is submerged in cooling water stored in the water tank 3, but part of the gas-liquid contact tower 42 may be submerged in the water in the water tank 3.

As illustrated in FIG. 1A, an exhaust opening 422 that exhausts gas in the sealed space 421 out of the gas-liquid contact tower 42 may be now provided at the lower part of the peripheral wall of the gas-liquid contact tower 42, and the surface level of the target water in the gas-liquid contact tower 42 may be preferably set to above the exhaust opening 422. This configuration can form the sealed space 421 in the gas-liquid contact tower 42, and allows the degassing gas that has absorbed dissolved oxygen in the target water to be discharged from the exhaust opening 422. In order to discharge the degassing gas in the gas-liquid contact tower 42 only from the exhaust opening 422, the bubble size of the degassing gas can be increased and the degassing gas discharged out of the gas-liquid contact tower 42 can rise to the surface of the target water (cooling water) stored in the water tank 3. This configuration can suppress inflow of bubbles of the degassing gas into the circulating pump 5 that circulates the cooling water stored in the water tank 3 through the cooling target facility 2 or the like, and also can prevent damage of the circulating pump 5.

The degassing gas supply unit 43 includes a degassing gas generation part 431 and a degassing gas delivery pipe 432. The degassing gas generation part 431 is a device that generates a degassing gas, and examples thereof include gas cylinders filled with the degassing gas. One end of the degassing gas delivery pipe 432 is connected to the supply port of the degassing gas generation part 431, and the other end is inserted into the gas-liquid contact tower 42. In this state, the degassing gas delivery pipe 432 is fixed to the gas-liquid contact tower 42 with a gas delivery pipe fixing member (not shown). As a degassing gas generated from the degassing gas generation part 431, for example, inert gases such as nitrogen gas can be used. In addition, fixing the degassing gas delivery pipe 432 facing upward to the gas-liquid contact tower 42 allows the degassing gas that has absorbed dissolved oxygen in the gas-liquid contact tower 42 to be easily discharged from a discharge opening.

With the above configuration, in the deoxidation apparatus 4 of the present embodiment, the target water is dispersed in the form of a mist with the dispersion nozzle unit 412 while the gas-liquid contact tower 42 is filled with the degassing gas generated from the degassing gas generation part 431. Accordingly, the droplet size of the target water can be decreased, whereby the surface area of droplets for equivalent volume of water is increased to increase the contact area with the degassing gas. As a result, the dissolved oxygen concentration of the target water can be lowered.

The deoxidation apparatus 4 of the present embodiment generates no fine bubbles of the degassing gas in the target water (cooling water) stored in the water tank 3 because the target water is brought into contact with the degassing gas with the gas-liquid contact tower 42 being filled with the degassing gas. The degassing gas in the gas-liquid contact tower 42 is thus prevented from reaching the circulating pump 5 that disadvantageously circulates the degassing gas as bubbles through the cooling water circulating system 11, which causes no cavitation.

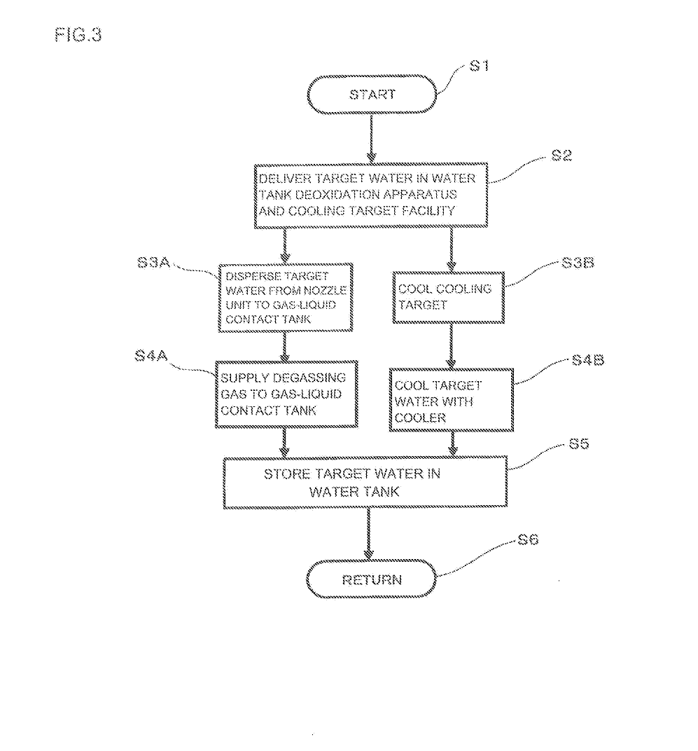

Next, the deoxidation treatment method in the cooling water circulation system 1 to which the present embodiment is applied will be described with reference to FIG. 3. In the initial state, the gas-liquid contact tower 42 is filled with the degassing gas, and a predetermined amount of the target water is stored in the water tank 3 (Step S1). In addition, the first flow control valve 72 and the second flow control valve 73 are in the state of open.

First, the target water stored in the water tank 3 is allowed to pass through the first flow control valve 72 and the second flow control valve 73 with the circulating pump 5, and continuously delivered to each of the deoxidation apparatus 4 side and the cooling target facility 2 side (Step S2). The target water delivered to the deoxidation apparatus 4 side is allowed to pass through the dispersion connecting pipe 411 and dispersed in the form of a mist in the gas-liquid contact tower 42 from the dispersion nozzle unit 412 (Step S3A). Dissolved oxygen in the target water dispersed in the form of a mist is absorbed by the degassing gas in the gas-liquid contact tower 42, and the target water drops to the surface 423 of the target water. Dissolved oxygen in the target water is absorbed by the degassing gas while part of this target water dispersed in the form of a mist adheres to the inner wall surface of the gas-liquid contact tower 42, moves on the inner wall surface of the gas-liquid contact tower 42 and drops to the surface 423 of the target water. The oxygen dissolved in the target water dispersed in the form of a mist with the dispersion nozzle unit 412 is thus absorbed by the degassing gas stored in the gas-liquid contact tower 42, thereby lowering the dissolved oxygen concentration of the target water stored in the water tank 3.

The degassing gas generation part 431 continuously supplies the degassing gas to the gas-liquid contact tower 42 through the degassing gas delivery pipe 432 (Step S4A). As accompanied by the supply of the degassing gas from this degassing gas generation part 431, the degassing gas that has absorbed dissolved oxygen in the target water moves to the lower part of the gas-liquid contact tower 42 and is discharged out of the gas-liquid contact tower 42 from the exhaust opening 422. This configuration always keeps the degassing gas in the gas-liquid contact tower 42 in the fresh conditions, and thus can continue the deoxidation treatment with the degassing gas in the gas-liquid contact tower 42.

The cooling water (target water) delivered to the cooling target facility 2 side is supplied to the cooling target facility 2, so that the cooling water absorbs the heat inside the cooling target facility 2 (Step S3B). The cooling water which has been warmed by absorbing the heat inside the cooling target facility 2 is then delivered to the cooler 6 with the circulating pump 5 and cooled (Step S4B).

As described above, the target water dispersed from the dispersion nozzle unit 412 and the cooling water cooled by the cooler 6 are stored in the water tank 3 (Step S5). This target water (cooling water) stored in the water tank 3 is continuously delivered to the deoxidation apparatus 4 and the cooling target facility 2 with the circulating pump 5 again (Steps S1 and S2).

In this manner, the lowering of the dissolved oxygen concentration of the target water stored in the water tank 3 with the deoxidation apparatus 4 and the circulation of the target water (cooling water) having a low dissolved oxygen concentration and a low temperature through the cooling target facility 2 can prevent corrosion of the cooling target facility 2, the cooler 6, and the circulating pipe 7. In addition, controlling corrosion of these devices and the circulating pipe 7 can prevent occurrence of water contamination (occurrence of red water, etc.) due to iron oxide dissolved in the target water.

### Second Embodiment

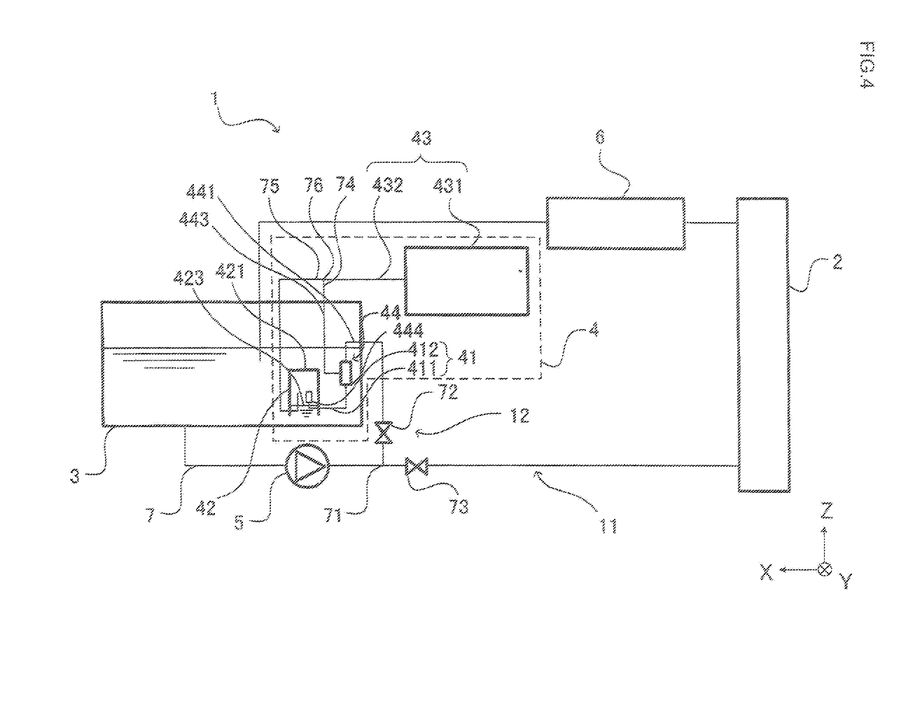

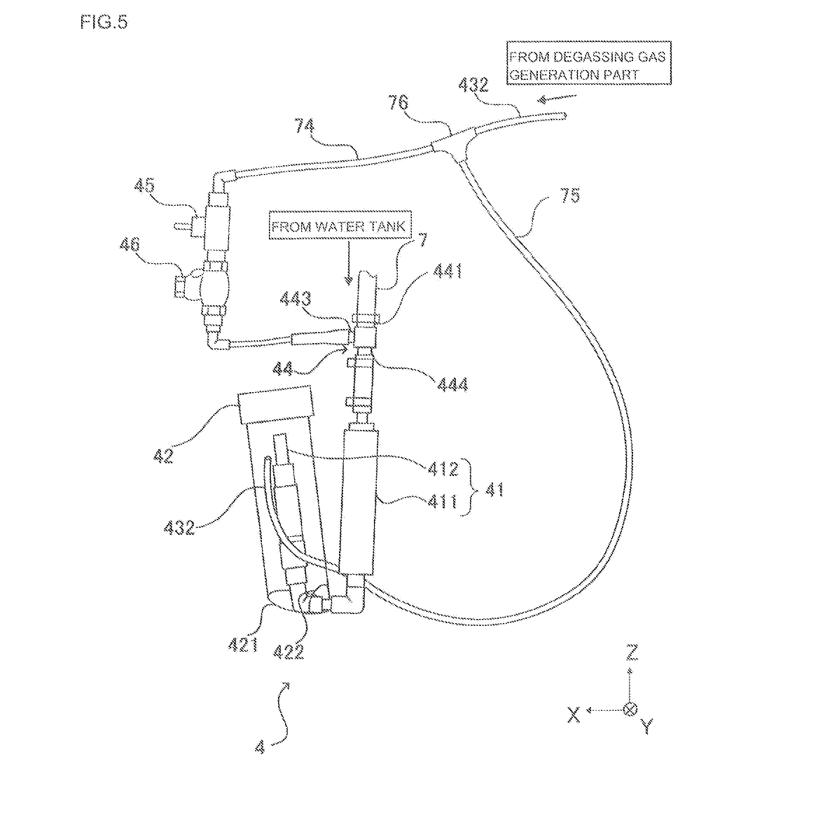

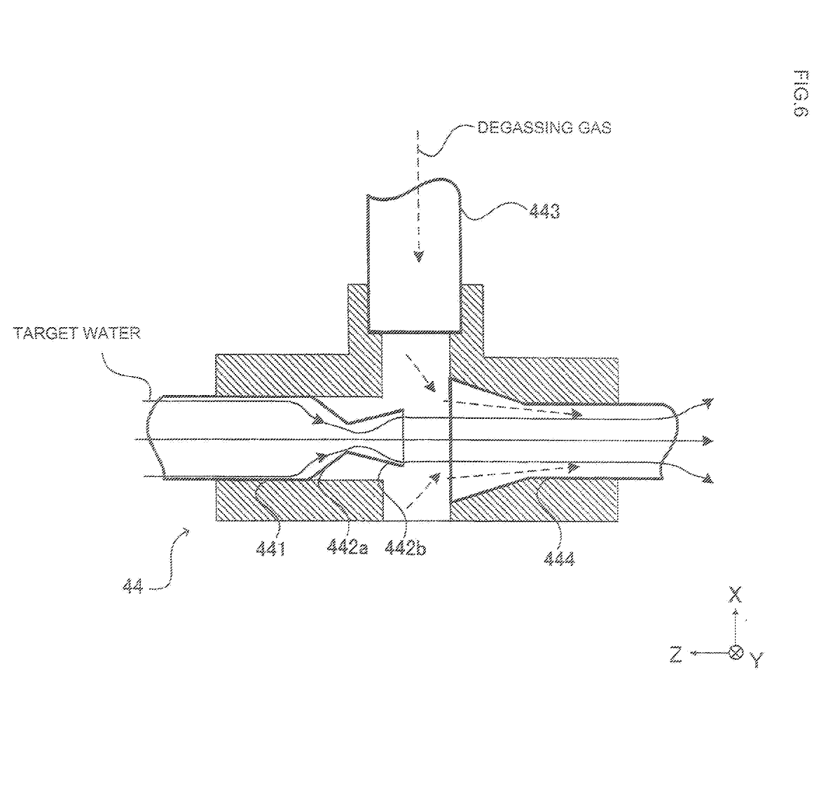

FIG. 4 is a schematic diagram of a cooling water circulating system 1 to which a deoxidation apparatus 4 of the second embodiment is applied; FIG. 5 is a schematic diagram of the deoxidation apparatus 4 of the second embodiment; and FIG. 6 is an x-z cross-sectional view of an ejector 44 in the second embodiment. The coordinate system is the same as that in the first embodiment.

The deoxidation apparatus 4 of the second embodiment includes the ejector 44 between the first flow control valve 72 and the dispersion connecting pipe 411 in the deoxidation apparatus 4 of the first embodiment. In the middle of the degassing gas delivery pipe 432, the deoxidation apparatus 4 includes a first degassing delivery pipe 74 for delivering the degassing gas generated from the degassing gas generation part 431 to the ejector 44 and a gas branch point which is configured to diverge the degassing gas generated for on the degassing gas generation part 431 to a second gas delivery pipe 75. Since other elements are the same as those in the deoxidation apparatus 4 of the first embodiment, same members are designated by same reference numerals and the description thereof is omitted.

The ejector 44 mixes fine bubbles of the degassing gas into the target water (cooling water) supplied from the branch connecting pipe 71. In a specific configuration, the ejector 44, as illustrated in FIG. 6, has a target water inlet passage 441, a degassing gas inlet passage 443, and a mixed water outlet passage 444.

The target water inlet passage 441 on the downstream side includes a diameter-reducing section 442a which is narrowed toward the end and a diameter-increasing section 442b which is widen toward the end, and increases the outflow rate of the target water from the target water inlet passage 441. With the increase in the rate of the target water, the inside of the ejector 44 becomes under negative pressure so that the degassing gas is allowed to flow into the ejector 44 from the degassing gas inlet passage 443. When this inflow degassing gas is mixed with the target water having an increased speed in the ejector 44, the degassing gas in the form of fine bubbles is mixed with the target water and the mixture flows from the mixed water outlet passage 444 to the target water dispersion unit 41.

This configuration produces fine target water by mixing the target water with the degassing gas before dispersion of the target water from the target water dispersion unit 41, and accordingly the particle size of the target water dispersed from the target water dispersion unit 41 can be still smaller than that of the target water dispersed from the target water dispersion unit 41 in the first embodiment. This can increase the contact area between the target water dispersed from the target water dispersion unit 41 and the degassing gas with which the gas-liquid contact tower 42 is filled.

The degassing gas bubbles mixed with the target water dispersed in the form of a mist in the gas-liquid contact tower 42 from the dispersion nozzle unit 412 are separated from the target water and released into the gas-liquid contact tower 42 when adhering to the inner wall surface of the gas-liquid contact tower 42, or when being dispersed into the space in the gas-liquid contact tower 42. Even after the target water dispersed in the form of a mist and containing the degassing gas bubbles drops to the surface 423 of the target water, the degassing gas bubbles gradually rise to the upper part of the gas-liquid contact tower 42 as restricted by the bottom inner wall surface of the gas-liquid contact tower 42, thereby preventing the degassing gas bubbles from reaching the circulating pump 5.

Here, as illustrated in FIG. 5, a third flow control valve 45 may be provided between the gas branch point 76 and the target water dispersion unit 41. Because the inside of the ejector 44 is under negative pressure, the amount of the degassing gas delivered to the first degassing gas delivery pipe 74 is larger than that of the degassing gas delivered to the second degassing gas delivery pipe 75. When a large amount of the degassing gas generated from the degassing gas generation part 431 flows into the first degassing gas delivery pipe 74 in this manner, the amount of the degassing gas supplied to the gas-liquid contact tower 42 through the second degassing gas delivery pipe 75 is too small to sufficiently absorb oxygen dissolved in the target water in the gas-liquid contact tower 42. The third flow control valve 45 is thus provided in the middle of the first degassing gas delivery pipe 74 to control the amount of the degassing gas flowing into the ejector 44. This configuration can also deliver the degassing gas to the ejector 44 while ensuring a sufficient amount of the degassing gas stored in the gas-liquid contact tower 42.

As illustrated in FIG. 5, a check valve 46 may be provided downstream of the third flow control valve 45. This configuration can prevent the target water flowing into the ejector 44 from flowing backward to the degassing gas generation part 431 even when the amount of the target water flowing into the ejector 44 from the target water inlet passage 441 is much larger than that of the degassing gas flowing into the ejector 44 from the degassing gas inlet passage 443.

### Third Embodiment

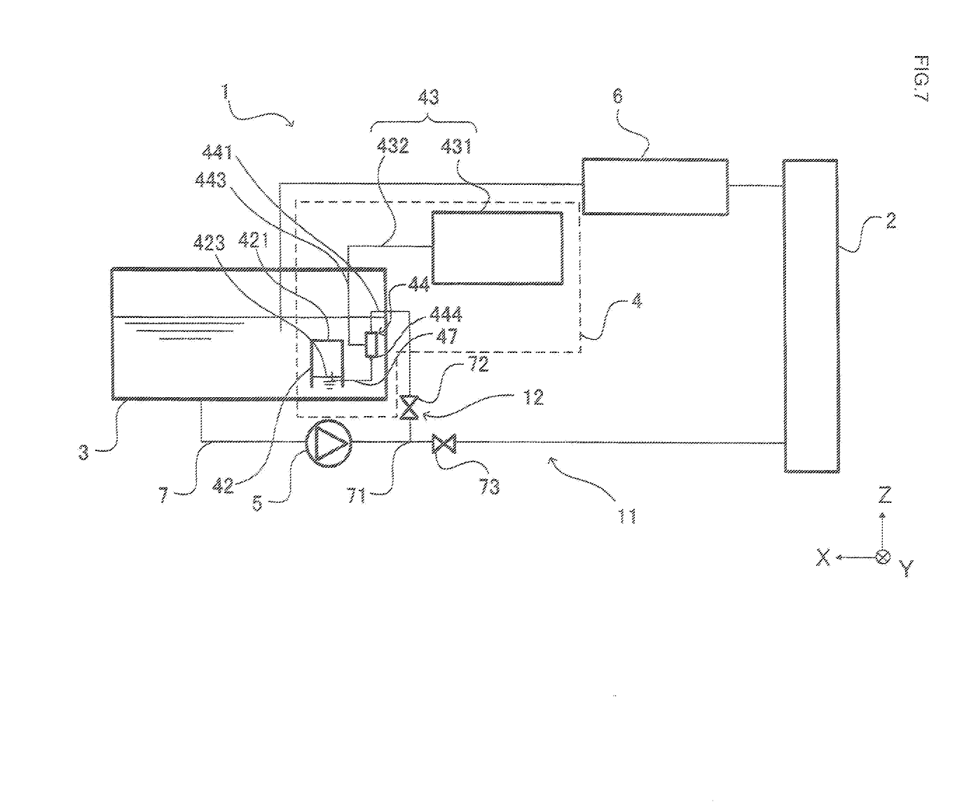

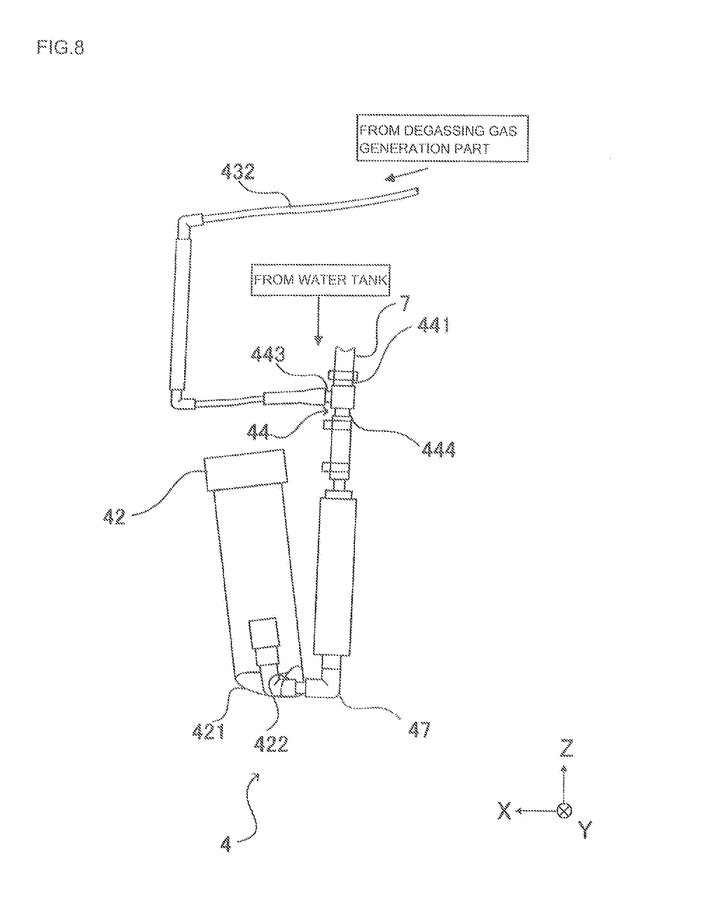

FIG. 7 is a schematic diagram of a cooling water circulating system 1 to which a deoxidation apparatus 4 of the third embodiment is applied; and FIG. 8 is a schematic diagram of the deoxidation apparatus 4 of the third embodiment. The coordinate system is the same as that in the first embodiment.

The deoxidation apparatus 4 of the third embodiment includes an ejection part 47 instead of the target water dispersion unit 41 in the second embodiment and has no second gas delivery pipe 75 in the second embodiment. Since other elements are the same as those in the deoxidation apparatus 4 of the second embodiment, same members are designated by same reference numerals and the description thereof is omitted.

The ejection part 47, as illustrated in FIG. 8, is fixed to the gas-liquid contact tower 42 while one end of the ejection part 47 is connected to the ejector 44 and the other end is positioned inside the gas-liquid contact tower 42 with the other end facing upward. As described in the second embodiment, the degassing gas generated from the degassing gas generation part 431 and the target water supplied from the circulating pump 5 are mixed with each other with the degassing gas being in the form of fine bubbles in the ejector 44, and then delivered to the ejection part 47 with the degassing gas being contained in the target water. The target water and the degassing gas in this mixing state are ejected from the ejection part 47, and part of the degassing gas mixed in the target water is released in the sealed space 421 of the gas-liquid contact tower 42. The degassing gas bubbles remaining in the target water are also released in the gas-liquid contact tower 42 as restricted by the lower inner wall surface of the gas-liquid contact tower 42 and prevented from moving out of the gas-liquid contact tower 42. This configuration can prevent fine bubbles of the degassing gas from flowing into the circulating pump 5 because the deoxidation apparatus 4 of the present embodiment has the configuration where the degassing gas is released in the gas-liquid contact tower 42 even with the degassing gas bubbles being contained in the target water. The deoxidation apparatus 4 of the present embodiment causes fine bubbles of the degassing gas to be mixed in the target water between the ejector 44 and the ejection part 47, and thus allows oxygen dissolved in the target water to be absorbed by the degassing gas, thereby lowering the dissolved oxygen concentration of the target water stored in the water tank 3.

The deoxidation apparatus 4 of the third embodiment may also include a check valve 46 between the degassing gas generation part 431 and the ejector 44 in order to prevent the target water from flowing into the ejector 44 from the target water inlet passage 441.

### (Comparison Confirmation Test for Deoxidization Performance)

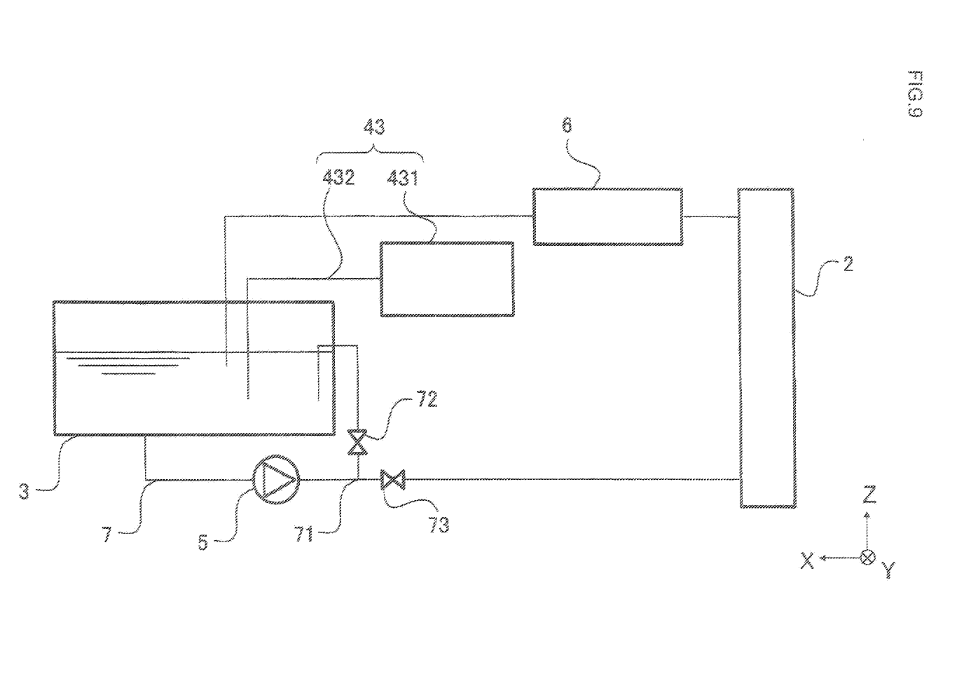

The confirmation test was carried out to confirm the deoxidation performance in the deoxidation apparatuses 4 of the first to third embodiments. The cooling water circulation systems 1 to which the deoxidation apparatuses 4 in the first, second, and third embodiments are applied are illustrated in FIGS. 1, 4, and 7, and referred to as Examples 1, 2, and 3, respectively. It is noted that the cooling target facility 2 and the cooler 6 are omitted because the purpose here is to confirm the deoxidation performance. In order to confirm the deoxidation performance in the deoxidation apparatuses 4 of Examples 1 to 3, the test to confirm the deoxidation performance was also carried out for a deoxidation apparatus (hereinafter, referred to as Comparative Example) where a degassing gas generated from a degassing gas generation part 431 is directly injected to a water tank 3 for the deoxidation treatment as illustrated in FIG. 9. As the test conditions for the deoxidation apparatuses 4 in Examples 1 to 3 and Comparative Example here, 140 L of tap water was stored in the water tank 3, CH12-40 manufactured by Grundfos was used as the circulating pump 5, and nitrogen gas was used as the gas generated from the degassing gas generation part 431. The inflow volume of nitrogen gas flowing into the water tank 3 from the degassing gas generation part 431, and the circulating volume of the target water through the entire apparatus and through the deoxidation apparatus 4 from the water tank 3 are as described in Table 1. An oxygen analyzer was provided in the water tank 3, and the measurement was carried out every 10 minutes for 110 minutes.

TABLE 1
SUPPLY VOLUME OF NITROGEN GAS AND
CIRCULATING FLOWRATE OF TARGET WATER

| | | SUPPLY | CIRCULATION OF TARGET | |
|---|---|---|---|---|
| | | VOLUME | WATER [L/min] | |
| | | OF NITRO- | | CIRCULATING |
| | | GEN GAS | CIRCULATING | FLOW RATE |
| | TREAT- | FLOW | FLOW RATE | (DEOXIDATION |
| | MENT | RATE | (ENTIRE | TREATMENT |
| No. | METHOD | [NL/min] | APPARATUS) | UNIT) |
| \textcircled{1} | EXAM- | 0.5 | 160 | 13 |
| | PLE 1 | | | |
| \textcircled{2} | EXAM- | 3.0 | 160 | 12 |
| | PLE 2 | | | |
| \textcircled{3} | EXAM- | 0.5 | 160 | 13 |
| | PLE 3 | | | |
| \textcircled{4} | COMPAR- | 3.0 | 160 | 14 |
| | ATIVE | | | |
| | EXAMPLE | | | |

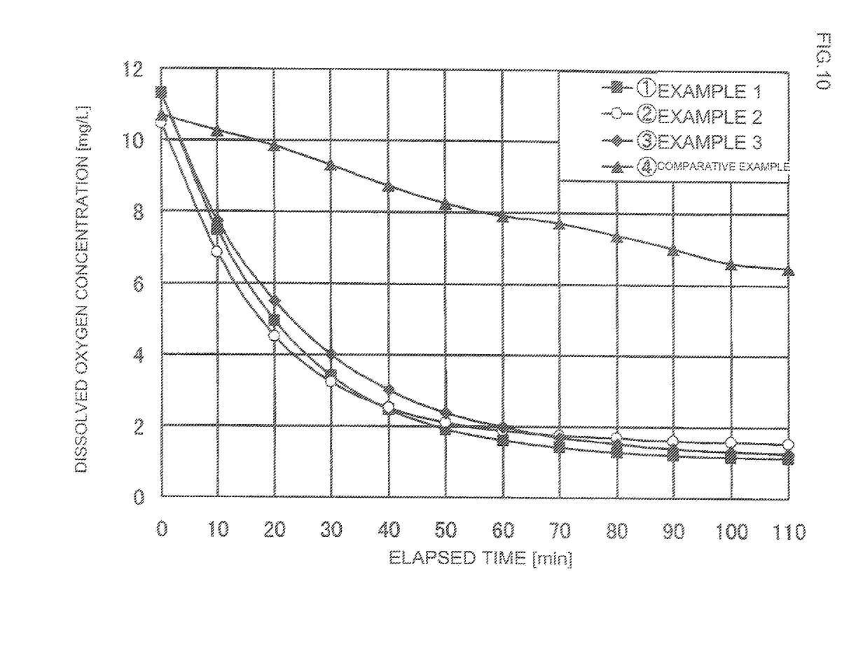

The test results for the cooling water circulation systems 1 in Examples 1 to 3, and Comparative Example under the above test conditions are shown in FIG. 10. As shown in FIG. 10, in the cooling water circulating systems 1 to which the deoxidation apparatuses 4 of Examples 1 to 3 are applied, the dissolved oxygen concentration of the target water is found to decrease to below about 2 [mg/L] in 110 minutes after the deoxidation treatment starts. On the other hand, in the cooling water circulation system 1 to which the deoxidation apparatus 4 in Comparative Example is applied, the dissolved oxygen concentration of the target water stored in the water tank 3 is found to decrease only to 6.5 [mg/L] even 110 minutes after the deoxidation treatment starts. That is, the deoxidation apparatuses 4 of Examples 1 to 3 can decrease the dissolved oxygen concentration to about half or less of that in Comparative Example by the deoxidation treatment for 110 minutes.

In the above test results, when compared with Comparative Example where nitrogen gas is simply contained in the water tank 3, the deoxidation apparatuses 4 of Examples 1 to 3 can lower the dissolved oxygen concentration of the target water stored in the water tank 3 by increasing the contact area between nitrogen gas and the target water.

Although the present invention has been described on the basis of the first to third embodiments, various modifications and changes made thereto will be apparent to those skilled in the art without departing from the spirit and scope of the present invention.

### REFERENCE SIGNS LIST

1 cooling water circulation system
11 cooling water circulating system, 12 deoxidation treatment water circulating system
2 cooling target facility
3 water tank
4 deoxidation apparatus
41 target water dispersion unit, 411 dispersion connecting pipe, 412 dispersion nozzle unit
42 gas-liquid contact tower, 421 sealed space, 422 exhaust opening, 423 surface of target water
43 degassing gas supply unit, 431 degassing gas generation part, 432 degassing gas delivery pipe
44 ejector, 441 target water inlet passage, 442a diameter-reducing section, 442b diameter-increasing section, 443 degassing gas inlet passage, 444 mixed water outlet passage
45 third flow control valve, 46 check valve, 47 ejection part
5 circulating pump
6 cooler (heat exchange means)
7 circulating pipe
71 branch connecting pipe, 72 first flow control valve, 73 second flow control valve, 74 first degassing gas delivery pipe, 75 second degassing gas delivery pipe, 76 gas branch point

1. A deoxidation apparatus involving bringing a degassing gas into contact with target water, which causes dissolved oxygen in the target water to be absorbed by the degassing gas and lowers the dissolved oxygen concentration of the target water, the deoxidation apparatus comprising:
a gas-liquid contact tower that has a shape of a container open at a lower end thereof, at least the lower end being submerged below a surface of the target water to be treated, the gas-liquid container thereby forming an internal sealed space;
a degassing gas supply unit that supplies the degassing gas to the sealed space to fill the sealed space with the degassing gas; and
a target water dispersion unit that disperses supplied target water within the sealed space in the form of a mist through a dispersion nozzle unit.

2. The deoxidation apparatus according to claim 1, wherein the degassing gas and the target water are ejected upward.

3. The deoxidation apparatus according to claim 1, wherein the gas-liquid contact tower is placed in a water tank for storing the target water.

4. The deoxidation apparatus according to claim 1, wherein an exhaust opening that exhausts gas in the sealed space out of the tank is provided at a lower part of a peripheral wall of the gas-liquid contact tower, and a surface level of the target water in the gas-liquid contact tower is set to be above the opening.

5. The deoxidation apparatus according to claim 1, involving an ejector that premixes the degassing gas with the target water to be supplied to the dispersion nozzle unit.
